(19) United States
(12) Patent Application Publication
(10) Pub. No.: US 2025/0310739 A1
(43) Pub. Date: Oct. 2, 2025

(54) IN-VEHICLE APPARATUS, INFORMATION PROCESSING METHOD, AND PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Masashi WATANABE, Yokkaich-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/864,235

(22) PCT Filed: May 8, 2023
(86) PCT No.: PCT/JP2023/017298

§ 371 Date: Nov. 8, 2024

(30) Foreign Application Priority Data
May 20, 2022 (JP) 2022-083224

(51) Int. Cl. H04W 4/48; H04L 12/22; H04L 43/0852; H04L 67/12

(52) U.S. Cl. CPC H04W 4/48; H04L 12/22; H04L 43/0852; H04L 67/12

(57) ABSTRACT

An in-vehicle apparatus is an in-vehicle apparatus installed in a vehicle and configured to perform communication with at least one in-vehicle device connected to an in-vehicle network of the vehicle, the in-vehicle apparatus including a control unit configured to perform control related to the communication, wherein the control unit acquires a sending time point and a reception time point of communication data sent and received during the communication with the in-vehicle device, and determines whether or not the in-vehicle device that has performed the communication is an unauthorized device based on the acquired sending time point and reception time point.

### CROSS-REFERENCE TO RELATED APPLICATIONS

This application is the U.S. national stage of PCT/JP2023/017298 filed on May 8, 2023, which claims priority of Japanese Patent Application No. JP 2022-083224 filed on May 20, 2022, the contents of which are incorporated herein.

### TECHNICAL FIELD

The present disclosure relates to an in-vehicle apparatus, an information processing method, and a program.

### BACKGROUND

Vehicles are equipped with in-vehicle networks. In addition, in-vehicle communication systems have been developed to enhance the security of the in-vehicle networks. For example, an in-vehicle communication system disclosed in JP 2016-116075A is an in-vehicle communication system that performs message authentication using a sender code, which is a message authentication code generated by a sender of communication data, and a receiver code, which is a message authentication code generated by a receiver of the communication data, the system including: a first ECU that is connected to an in-vehicle network and holds only a first encryption key, among the first encryption key and a second encryption key that is different from the first encryption key; a second ECU that is connected to the in-vehicle network and holds at least the first encryption key; and a third ECU that is connected to the in-vehicle network and to an extra-vehicle network, holds only the second encryption key, among the first and second encryption keys, and generates the sender code or the receiver code using the second encryption key during communication within the in-vehicle network, wherein the second ECU sends communication data with the sender code generated using the first encryption key, and when the first ECU receives the communication data, the first ECU verifies the sender code attached to the received communication data using the receiver code generated using the first encryption key.

However, JP 2016-116075A has the problem in that if any encryption key is obtained through unauthorized means, security will be compromised.

In view of such circumstances, an object of the present disclosure is to provide an in-vehicle apparatus or the like configured to detect an unauthorized device connected to an in-vehicle network.

### SUMMARY

An in-vehicle apparatus according to an aspect of the present disclosure is an in-vehicle apparatus installed in a vehicle and configured to perform communication with at least one in-vehicle device connected to an in-vehicle network of the vehicle, the in-vehicle apparatus including a control unit configured to perform control related to the communication, wherein the control unit acquires a sending time point and a reception time point of communication data sent and received during the communication with the in-vehicle device, and determines whether or not the in-vehicle device that has performed the communication is an unauthorized device based on the acquired sending time point and reception time point.

### Effects

According to an aspect of the present disclosure, it is possible to detect an unauthorized device connected to an in-vehicle network.

### BRIEF DESCRIPTION OF DRAWINGS

FIG. 1 is a schematic diagram illustrating an example of the system configuration of an in-vehicle system according to Embodiment 1.

FIG. 2 is a block diagram illustrating an example of the internal configuration of an in-vehicle apparatus (integrated ECU) and the like.

FIG. 3 is an explanatory diagram illustrating an example of an estimated-required-time table.

FIG. 4 is an explanatory diagram illustrating examples of time points during communication between the in-vehicle apparatus and an in-vehicle device.

FIG. 5 is a flowchart illustrating the processing executed by a control unit of the in-vehicle apparatus according to Embodiment 1.

FIG. 6 is a flowchart illustrating an unauthorized device estimation process.

FIG. 7A is an explanatory diagram showing an example of the connection of an unauthorized device.

FIG. 7B is an explanatory diagram showing another example of the connection of an unauthorized device.

FIG. 8 is an explanatory diagram illustrating an example of an estimated-required-time table according to Embodiment 2.

FIG. 9 is a flowchart illustrating the processing executed by the control unit of the in-vehicle apparatus according to Embodiment 2.

FIG. 10 is a flowchart illustrating an unauthorized device estimation process according to Embodiment 2.

### DETAILED DESCRIPTION OF PREFERRED EMBODIMENTS

First, embodiments of the present disclosure will be listed and described. At least some of the embodiments described below may be combined with each other as appropriate.

An in-vehicle apparatus according to an aspect of the present disclosure is an in-vehicle apparatus installed in a vehicle and configured to perform communication with at least one in-vehicle device connected to an in-vehicle network of the vehicle, the in-vehicle apparatus including a control unit configured to perform control related to the communication, wherein the control unit acquires a sending time point and a reception time point of communication data sent and received during the communication with the in-vehicle device, and determines whether or not the in-vehicle device that has performed the communication is an unauthorized device based on the acquired sending time point and reception time point.

In this aspect, the control unit of the in-vehicle apparatus acquires a time point at which the in-vehicle apparatus has sent communication data to the in-vehicle device, a time point at which the in-vehicle device has received the communication data, a time point at which the in-vehicle device has sent communication data to the in-vehicle apparatus, and a time point at which the in-vehicle apparatus has received the communication data. The in-vehicle apparatus is connected via harnesses to in-vehicle devices (authorized devices) officially installed in the vehicle. The lengths of the harnesses connecting the in-vehicle apparatus to the respective authorized devices are specified based on the vehicle model because the arrangement of the in-vehicle apparatus and the authorized devices within the vehicle is unique to each vehicle model. The time needed for communication between the in-vehicle apparatus and a particular in-vehicle device is a value that depends on the length of the harness between a connection point to which the in-vehicle apparatus is connected and a connection point to which that in-vehicle device is connected. This time (required communication time) is determined based on the physical positional relationship between the in-vehicle apparatus and the in-vehicle device. If an unauthorized device that simulates an authorized device is connected to a communication path in the harness between the in-vehicle apparatus and the authorized device, the time needed for communication between the in-vehicle apparatus and this in-vehicle device will differ from an estimated time. The in-vehicle apparatus calculates the time taken for communication with the in-vehicle device based on the sending time point and the reception time point at the in-vehicle apparatus and the in-vehicle device, and then determines whether or not the in-vehicle device that has performed the communication is an unauthorized device based on the calculated time. Thus, it possible to detect an unauthorized device that simulates an authorized device and is connected to the in-vehicle network.

In the in-vehicle apparatus according to an aspect of the present disclosure, the sending time point is a time point at which the sending of the communication data is completed, and the reception time point is a time point at which the reception of the communication data is completed.

In this aspect, the control unit of the in-vehicle apparatus acquires the time point at which the in-vehicle apparatus or the in-vehicle device has completed the sending of communication data as the sending time point, and also acquires the time point at which the in-vehicle apparatus or the in-vehicle device has completed the reception of communication data as the reception time point. By acquiring the time points of completion as both the sending time point and the reception time point, it is possible to acquire the sending time point and the reception time point only when the communication between the in-vehicle apparatus and the in-vehicle device has been completed normally.

In the in-vehicle apparatus according to an aspect of the present disclosure, the control unit determines whether or not the in-vehicle device that has performed the communication is an unauthorized device by comparing an estimated required time stored in an accessible storage area in advance, with a required time between the sending time point and the reception time point.

In this aspect, the storage area accessible by the control unit of the in-vehicle apparatus stores a pre-measured estimated required time for communication between the in-vehicle apparatus and an authorized device. The control unit of the in-vehicle apparatus determines whether or not the in-vehicle device that has performed the communication is an unauthorized device by comparing the estimated required time stored in the storage area with the time (measured required time) actually taken for communication between the in-vehicle apparatus and the in-vehicle device. Thus, the control unit of the in-vehicle apparatus can detect an unauthorized device that simulates an authorized device and is connected to the in-vehicle network.

In the in-vehicle apparatus according to an aspect of the present disclosure, the at least one in-vehicle device includes a plurality of in-vehicle devices, and the estimated required time includes estimated required times, each representing an estimated duration from the sending time point to the reception time point of communication data, when the communication is performed with each of the plurality of in-vehicle devices connected to the in-vehicle network separately.

In this aspect, the in-vehicle apparatus performs communication with a plurality of in-vehicle devices. The storage area accessible by the control unit of the in-vehicle apparatus stores estimated required times representing estimated durations from sending time points at the in-vehicle apparatus to reception time points at the respective authorized devices when the in-vehicle apparatus sends communication data to each of the plurality of authorized devices separately, and also stores estimated required times representing estimated durations from sending time points at the respective authorized devices to reception time points at the in-vehicle apparatus. The control unit of the in-vehicle apparatus can determine whether or not the in-vehicle device that has performed the communication is an unauthorized device by comparing each of the estimated required times with the time (measured required time) actually taken for communication between the in-vehicle apparatus and the in-vehicle device.

In the in-vehicle apparatus according to an aspect of the present disclosure, the control unit determines whether or not the in-vehicle device that has performed the communication is an unauthorized device based on a required time from the sending time point at which communication data has been sent to the reception time point at which the communication data has been received by the in-vehicle device.

In this aspect, if an unauthorized device is connected between the in-vehicle apparatus and an authorized device and performs communication with the in-vehicle apparatus by pretending to be the authorized device, the required time from the sending time point at which the in-vehicle apparatus sends communication data to the reception time point at which the unauthorized device receives the communication data will be shorter than when the in-vehicle apparatus and the authorized device perform communication with each other. In addition, if an unauthorized device relays communication between the in-vehicle apparatus and an authorized device and performs illegitimate processing, such as stealing or falsification of communication data, the required time from the sending time point at which the in-vehicle apparatus sends communication data to the reception time point at which the authorized device receives the communication data will be longer than when no relaying by the unauthorized device occurs. If the measured required time that has been actually taken for communication is shorter or longer than the estimated required time from when the in-vehicle apparatus sends communication data to when a device that performs communication receives the communication data, which is estimated when no unauthorized device is connected, the control unit of the in-vehicle apparatus determines that the in-vehicle device that has performed the communication is an unauthorized device. Thus, the control unit of the in-vehicle apparatus can detect an unauthorized device that simulates an authorized device and is connected to the in-vehicle network.

In the in-vehicle apparatus according to an aspect of the present disclosure, the control unit determines whether or not the in-vehicle device that has performed the communication is an unauthorized device based on a required time from the sending time point at which communication data has been sent from the in-vehicle apparatus to the reception time point at which the communication data has been received.

In this aspect, if an unauthorized device is connected between the in-vehicle apparatus and an authorized device and performs communication with the in-vehicle apparatus by pretending to be the authorized device, the measured required time from the sending time point at which the unauthorized device sends communication data to the reception time point at which the in-vehicle apparatus receives the communication data will be shorter than the estimated required time from the sending time point at which the authorized device sends communication data to the reception time point at which the in-vehicle apparatus receives the communication data. In addition, if an unauthorized device relays communication between the in-vehicle apparatus and an authorized device and performs illegitimate processing, such as stealing or falsification of communication data, the measured required time from the sending time point at which the authorized device sends communication data to the reception time point at which the in-vehicle apparatus receives the communication data will be longer than when no relaying by the unauthorized device occurs. If the measured required time that has been actually taken for communication is shorter or longer than the estimated required time from when a device that performs communication sends communication data to when the in-vehicle apparatus receives the communication data, which is estimated when no unauthorized device is connected, the control unit of the in-vehicle apparatus determines that the device that has performed the communication is an unauthorized device. Thus, the control unit of the in-vehicle apparatus can detect an unauthorized device that simulates an authorized device and is connected to the in-vehicle network.

In the in-vehicle apparatus according to an aspect of the present disclosure, the control unit determines whether or not the in-vehicle device that has performed the communication is an unauthorized device based on a required time from the reception time point at which communication data has been received by the in-vehicle device to the sending time point at which communication data has been sent from the in-vehicle device.

In this aspect, the control unit of the in-vehicle apparatus acquires the reception time point at which a device that has communicated has received communication data and the sending time point at which the device has sent communication data in response to the in-vehicle apparatus. Based on the acquired reception time point and sending time point, the control unit of the in-vehicle apparatus calculates the measured required time taken by the in-vehicle device that has communicated to perform processing for replying to the in-vehicle apparatus and return (send) communication data to the in-vehicle apparatus. Since the time taken by an authorized device to perform processing for responding to the in-vehicle apparatus is fixed, the control unit of the in-vehicle apparatus determines that a device that has communicated is an unauthorized device if the measured required time taken by the device that has communicated to perform processing for replying is shorter or longer than the estimated required time. Thus, the control unit of the in-vehicle apparatus can detect an unauthorized device that simulates an authorized device and is connected to the in-vehicle network.

In the in-vehicle apparatus according to an aspect of the present disclosure, if the required time is shorter than the estimated required time by the predetermined time or more, the control unit determines that an unauthorized device is performing the communication by pretending to be the in-vehicle device that is authorized.

In this aspect, if an unauthorized device is connected between the in-vehicle apparatus and an authorized device and performs communication with the in-vehicle apparatus by pretending to be the authorized device, the measured required time from the sending time point at which the unauthorized device sends communication data to the reception time point at which the in-vehicle apparatus receives the communication data will be shorter than the estimated required time from the sending time point at which the authorized device sends communication data to the reception time point at which the in-vehicle apparatus receives the communication data. The control unit of the in-vehicle apparatus determines that the in-vehicle device that has communicated is an unauthorized device if the measured required time is shorter than the estimated required time. Thus, the control unit of the in-vehicle apparatus can detect an unauthorized device that is connected between the in-vehicle apparatus and an authorized device and pretends to be the authorized device.

In the in-vehicle apparatus according to an aspect of the present disclosure, if the required time is longer than the estimated required time by the predetermined time or more, the control unit determines that an unauthorized device is relaying the communication with the in-vehicle device that is authorized.

In this aspect, if an unauthorized device relays communication between the in-vehicle apparatus and an authorized device and performs illegitimate processing, such as stealing or falsification of communication data, the required time from the sending time point at which the in-vehicle apparatus sends communication data to the reception time point at which the authorized device receives the communication data will be longer than when no relaying by the unauthorized device occurs. Also, the required time from the sending time point at which the authorized device sends communication data to the reception time point at which the in-vehicle apparatus receives the communication data will be longer than when no relaying by the unauthorized device occurs. The control unit of the in-vehicle apparatus determines that the in-vehicle device that has communicated is an unauthorized device if the measured required time is longer than the estimated required time. Thus, the control unit of the in-vehicle apparatus can detect an unauthorized device that relays communication between the in-vehicle apparatus and an authorized device.

In the in-vehicle apparatus according to an aspect of the present disclosure, if an absolute value of a difference between the estimated required time and the required time between the sending time point and the reception time point is greater than or equal to a predetermined time, the control unit determines that the in-vehicle device that has performed the communication is an unauthorized device.

In this aspect, the required time between the sending time point and the reception time point during communication between the in-vehicle apparatus and an authorized device is not exactly the same for every instance of communication, and a slight error occurs during each instance of communication. The control unit of the in-vehicle apparatus compares the estimated required time stored in the storage area with the time (measured required time) actually taken for communication between the in-vehicle apparatus and the in-vehicle device. Then, if the absolute value of the difference between the stored estimated required time and the measured required time is less than a predetermined time, the control unit of the in-vehicle apparatus determines that the in-vehicle device that has performed the communication is an authorized device. On the other hand, if the absolute value of the difference between the estimated required time stored and the measured required time is greater than or equal to the predetermined time, the control unit of the in-vehicle apparatus determines that the in-vehicle device that has performed the communication is an unauthorized device. Thus, it is possible to reduce the likelihood of the control unit of the in-vehicle apparatus of erroneously determining, when communication is performed with an authorized device, that the device that has performed the communication is an unauthorized device.

An information processing method according to an aspect of the present disclosure includes: acquiring a sending time point and a reception time point of communication data sent and received during communication with at least one in-vehicle device connected to an in-vehicle network of a vehicle; and
determining whether or not the in-vehicle device that has performed the communication is an unauthorized device based on the acquired sending time point and reception time point.

In this aspect, an in-vehicle apparatus calculates a measured required time taken for communication with the in-vehicle device based on the sending time point and the reception time point at the in-vehicle apparatus and the in-vehicle device, and then determines whether or not the in-vehicle device that has performed the communication is an unauthorized device based on the calculated measured required time. Thus, it possible to detect an unauthorized device that simulates an authorized device and is connected to the in-vehicle network.

With a non-transitory computer-readable storage medium storing a program according to an aspect of the present disclosure, the program causes a computer configured to perform communication with at least one in-vehicle device connected to an in-vehicle network of a vehicle to execute processing including: acquiring a sending time point and a reception time point of communication data sent and received during the communication with the in-vehicle device; and determining whether or not the in-vehicle device that has performed the communication is an unauthorized device based on the acquired sending time point and reception time point.

In this aspect, the in-vehicle apparatus calculates a measured required time taken for communication with the in-vehicle device based on the sending time point and the reception time point at the in-vehicle apparatus and the in-vehicle device, and then determines whether or not the in-vehicle device that has performed the communication is an unauthorized device based on the calculated measured required time. Thus, it possible to detect an unauthorized device that simulates an authorized device and is connected to the in-vehicle network.

The present disclosure will be described in detail based on the drawings showing embodiments thereof. Hereinafter, an in-vehicle apparatus according to these embodiments of the present disclosure will be described with reference to the drawings. It is to be noted that the present disclosure is not limited to examples given below, but is indicated by the appended claims, and all changes that come within the meaning and range of equivalency of the claims are intended to be embraced within the scope of the present disclosure.

### Embodiment 1

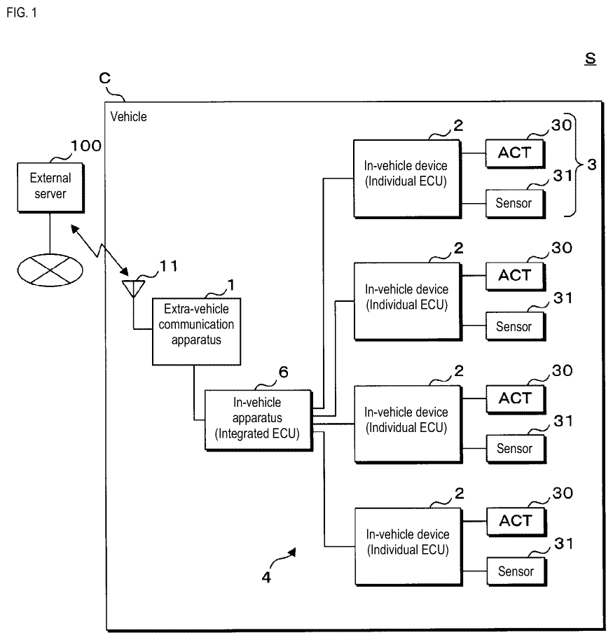

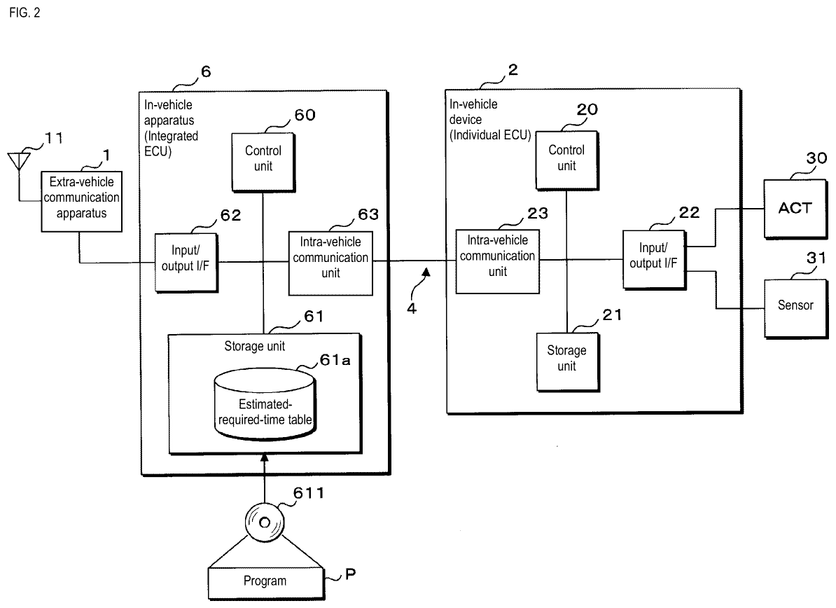

Embodiment 1 will be described below based on the drawings. FIG. 1 is a schematic diagram illustrating an example of the system configuration of an in-vehicle system S according to Embodiment 1. FIG. 2 is a block diagram illustrating an example of the internal configuration of an in-vehicle apparatus 6 and the like. The in-vehicle system S includes the in-vehicle apparatus (integrated ECU) 6 and a plurality of in-vehicle devices (individual ECUs) 2, which are all installed in a vehicle C. The individual ECUs 2 are each connected to vehicle components 3 such as an actuator 30 and a sensor 31.

The individual ECUs 2 are arranged in various areas within the vehicle C and are directly connected to the vehicle components 3, such as the actuators 30 for, for example, a car air conditioner, a wiper, a lamp, and the like, as well as the sensors 31, via wire harnesses such as serial cables (direct lines). Each of the individual ECUs 2, for example, acquires (receives) a signal (input signal) output from the sensor 31 and sends a request signal, generated based on the acquired input signal, to the integrated ECU 6. The individual ECU 2 controls the drive of the actuator 30 directly connected to it based on a control signal sent from the integrated ECU 6. In this manner, the individual ECU 2 drives the vehicle components 3, such as the actuator 30, connected to it under the control of the integrated ECU 6. The individual ECU 2 may be a relay control ECU that functions as an in-vehicle relay device, such as an Ethernet switch or gateway, relaying communication between multiple vehicle components 3 connected to that individual ECU 2 or between a certain vehicle component 3 and the integrated ECU 6.

The integrated ECU 6 generates and outputs control signals to each of the vehicle components 3 based on data from these vehicle components 3 relayed via the individual ECUs 2. For example, the integrated ECU 6 is a central control unit of a vehicle computer or the like. Based on information or data, such as a request signal, output (sent) from an individual ECU 2, the integrated ECU 6 generates a control signal for controlling the actuator 30 that is the target of the request signal, and outputs (sends) the generated control signal to the individual ECU 2. Multiple individual ECUs 2 are connected to the integrated ECU 6 via an in-vehicle network 4, and the controls of the actuators 30 may conflict due to request signals respectively sent from the multiple individual ECUs 2. To address this issue, the integrated ECU 6 may resolve the conflict between the controls of the actuators 30 by determining the priority order of the conflicting controls due to these request signals and performing processing according to the determined priority order. The integrated ECU 6 functions as an in-vehicle apparatus (corresponds to an in-vehicle apparatus) that determines whether or not an in-vehicle device that has performed communication with it is an unauthorized device based on a sending time point and a reception time point acquired during the communication with that in-vehicle device.

Examples of the vehicle components 3 include various sensors 31 such as LiDAR (Light Detection and Ranging), light sensors, CMOS cameras, and infrared sensors, as well as actuators 30 for switches, such as door SWs (switches) and lamp SWs, lamps, door opening and closing devices, motor devices, and the like.

An external server 100 is a computer, such as a server, connected to an extra-vehicle network, such as the Internet or a public network, for example, and includes a storage unit constituted by a RAM (Random Access Memory), a ROM (Read Only Memory), or a hard disk. The integrated ECU 6 may be communicably connected to an extra-vehicle communication apparatus 1, communicate with the external server 100 connected via an extra-vehicle network via the extra-vehicle communication apparatus 1, and relay communication between the external server 100 and the individual ECUs 2 or the vehicle components 3 installed in the vehicle C.

The extra-vehicle communication apparatus 1 includes an extra-vehicle communication unit (not shown) and an input/output I/F (not shown) for communicating with the integrated ECU 6. The extra-vehicle communication unit is a communication apparatus for wireless communication using mobile communication protocols, such as 4G, LTE (Long Term Evolution (registered trademark)), 5G, and WiFi (registered trademark), and sends and receives data to and from the external server 100 via an antenna 11 connected to the extra-vehicle communication unit. Communication between the extra-vehicle communication apparatus 1 and the external server 100 is performed via an external network N, such as a public network or the Internet, for example. The input/output I/F is a communication interface for serial communication, for example, with the integrated ECU 6. The extra-vehicle communication apparatus 1 and the integrated ECU 6 communicate with each other via the input/output I/F and a wire harness, such as a serial cable, connected to the input/output I/F. In the present embodiment, the extra-vehicle communication apparatus 1 is an apparatus separate from the integrated ECU 6, and these apparatuses are communicably connected to each other via the input/output I/F and the like, but there is no limitation to this configuration. The extra-vehicle communication apparatus 1 may be built into the integrated ECU 6 as a component of the integrated ECU 6. Furthermore, the integrated ECU 6 and the external server 100 may function as a central control unit in the vehicle C in conjunction or cooperation with each other.

The integrated ECU 6 includes a control unit 60, a storage unit 61, an input/output I/F 62, and an intra-vehicle communication unit 63. The control unit 60 is composed of a CPU (Central Processing Unit), an MPU (Micro Processing Unit), or the like, and is configured to perform various types of control processing, arithmetic processing, and the like by loading and executing a program P (program product) and data stored in the storage unit 61 in advance. The control unit 60 is not limited only to a software processing unit, such as a CPU, that performs software processing, but may also include a hardware processing unit, such as an FPGA, an ASIC, or an SOC, that performs various types of control processing, arithmetic processing, and the like through hardware processing.

The storage unit 61 is composed of a volatile memory element, such as a RAM (Random Access Memory), or a non-volatile memory element, such as a ROM (Read Only Memory), an EEPROM (Electrically Erasable Programmable ROM), or a flash memory. The program P (program product) and an estimated-required-time table 61a are stored in the storage unit 61 in advance. The program P (program product) stored in the storage unit 61 may be a program P (program product) that has been loaded from a recording medium 611 readable by the integrated ECU 6 and stored in the storage unit 61. The program P (program product) may also be a program P (program product) that has been downloaded from an external computer (not shown) connected to a communication network (not shown) and stored in the storage unit 61. Details of the estimated-required-time table 61a will be described later. Note that the control unit 60 of the integrated ECU 6 may load the estimated-required-time table 61a stored in the external server 100.

The input/output I/F 62 is a communication interface for serial communication, for example, as is the case with the input/output I/F of the extra-vehicle communication apparatus 1. The integrated ECU 6 is communicably connected to the extra-vehicle communication apparatus 1 via the input/output I/F 62 and a wire harness, such as a serial cable.

The intra-vehicle communication unit 63 is an input/output interface that uses, for example, the Ethernet (registered trademark) communication protocol, and the control unit 60 communicates with the individual ECUs 2 connected to the in-vehicle network 4 via the intra-vehicle communication unit 63. The intra-vehicle communication unit 63 includes, for example, a time synchronization function according to the AVB/TSN standard, and can store the time points at which the sending of communication data is completed and at which the reception of communication data is completed during communication with the individual ECUs 2. Alternatively, the time synchronization function according to the AVB/TSN standard may be implemented as a software processing unit (functional unit) in the control unit 60 of the integrated ECU 6. The control unit 60 of the integrated ECU 6 acquires the time points at which the sending of communication data is completed and at which the reception of communication data is completed, which are stored in the intra-vehicle communication unit 63, as the sending time point and the reception time point, respectively. Note that, the control unit 60 may alternatively acquire the time points at which the sending of communication data is started and at which the reception of communication data is started as the sending time point and the reception time point, respectively. The intra-vehicle communication unit 63 may also use the CAN (Control Area Network) communication protocol.

As is the case with the integrated ECU 6, the individual ECUs 2 each include a control unit 20, a storage unit 21, an input/output I/F 22, and an intra-vehicle communication unit 23. The control unit 20, the storage unit 21, the input/output I/F 22, and the intra-vehicle communication unit 23 of the individual ECUs 2 may have the same configurations as those of the integrated ECU 6.

The input/output I/F 22 of each of the individual ECUs 2 is directly connected to vehicle components 3, such as an actuator 30 and a sensor 31, via wire harnesses (direct lines) such as serial cables, for example.

The integrated ECU 6 and the plurality of individual ECUs 2, which are configured as described above, are communicably connected in a star-shaped network topology, as shown in FIG. 1, for example. Furthermore, adjacent individual ECUs 2 may be connected to each other to form a loop-shaped network topology, enabling bi-directional communication, and achieving redundancy.

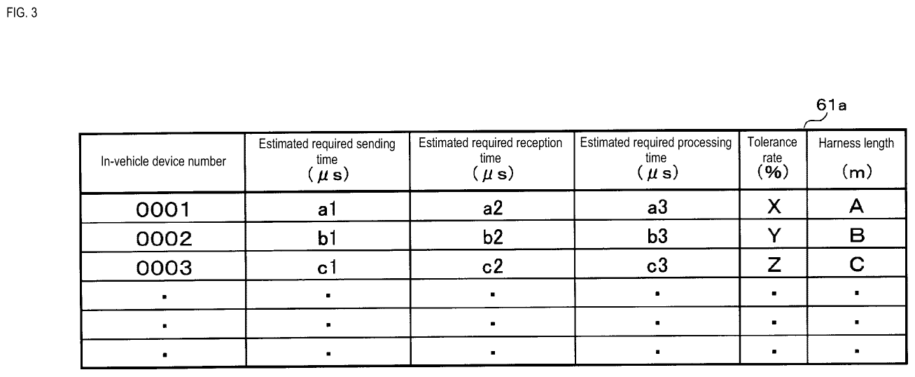

FIG. 3 is an explanatory diagram illustrating an example of the estimated-required-time table 61a. The estimated-required-time table 61a stores estimated times (estimated required times) needed for communication between the in-vehicle apparatus (integrated ECU) 6 and the in-vehicle devices (individual ECUs) 2. Examples of management items of the estimated-required-time table 61a include an “in-vehicle device number” field, an “estimated required sending time” field, an “estimated required reception time” field, an “estimated required processing time” field, a “tolerance rate” field, and a “harness length” field.

The “in-vehicle device number” field stores a number assigned to an in-vehicle device 2 that communicates with the in-vehicle apparatus 6. The “estimated required sending time” field stores an estimated required time (estimated required sending time) from the sending time point at the in-vehicle apparatus 6 to the reception time point at an in-vehicle device 2 when the in-vehicle apparatus 6 sends communication data to the in-vehicle device 2. The “estimated required reception time” field stores an estimated required time (estimated required reception time) from the sending time point at an in-vehicle device 2 to the reception time point at the in-vehicle apparatus 6 when the in-vehicle apparatus 6 receives communication data from the in-vehicle device 2. The “estimated required processing time” field stores an estimated required time (estimated required processing time) from the reception time point at an in-vehicle device 2 to the sending time point at that in-vehicle device 2, or in other words, an estimated time required by the in-vehicle device 2 to perform the processing for returning communication data to the in-vehicle apparatus 6.

The “tolerance rate” field stores the tolerance rate of an error relative to an estimated required time, which the control unit 60 of the in-vehicle apparatus 6 uses to determine that communication with an authorized in-vehicle device 2 has been performed. The “harness length” field stores the length of a harness connecting the in-vehicle apparatus 6 and an in-vehicle device 2.

The estimated required times stored in the “estimated required sending time” field, the “estimated required reception time” field, and the “estimated required processing time” field are the required times during communication between the in-vehicle apparatus 6 and the in-vehicle devices 2, as measured during an inspection before shipment or during a production process of the vehicle C. During the inspection before shipment or during the production process of the vehicle C, there is no risk of an unauthorized device being connected to the in-vehicle system S, and therefore it is possible to measure the required times during normal communication between the in-vehicle apparatus 6 and the in-vehicle devices 2. Note that values calculated based on the length of the harnesses connecting the in-vehicle apparatus 6 and the in-vehicle devices 2 may be stored in the “estimated required sending time” field and the “estimated required reception time” field.

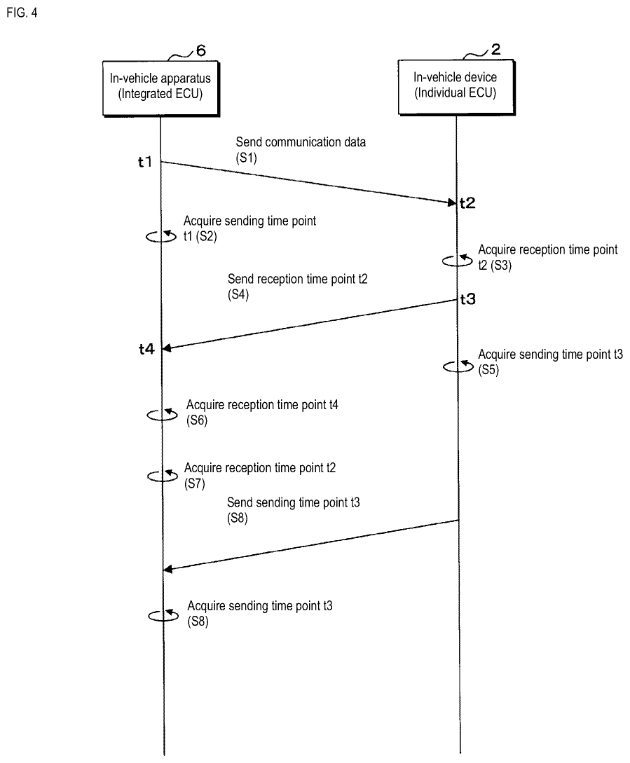

FIG. 4 is an explanatory diagram illustrating examples of time points during communication between the in-vehicle apparatus 6 and an in-vehicle device 2. The in-vehicle apparatus 6 sends communication data to the in-vehicle device 2 (S1). The communication data includes an instruction for the in-vehicle device 2 to send (return) the reception time point of the communication data to the in-vehicle apparatus 6, and an instruction for the in-vehicle device 2 to send, to the in-vehicle apparatus 6, the sending time point at which the in-vehicle device 2 sends the reception time point to the in-vehicle apparatus 6. The in-vehicle apparatus 6 acquires a sending time point t1 at which it has sent the communication data to the in-vehicle device 2 (S2). When the in-vehicle device 2 receives the communication data, it acquires a reception time point t2 (S3). The in-vehicle device 2 performs processing for sending a reply to the in-vehicle apparatus 6, and sends (returns) communication data including the reception time point t2 at the in-vehicle device 2 to the in-vehicle apparatus 6 (S4). The in-vehicle device 2 acquires a sending time point t3 at which it has sent (returned) the communication data to the in-vehicle apparatus 6 (S5). When the in-vehicle apparatus 6 receives the communication data sent (returned) from the in-vehicle device 2, it acquires a reception time point t4 (S6). In addition, the in-vehicle apparatus 6 acquires the reception time point t2 at the in-vehicle device 2 included in the communication data returned from the in-vehicle device 2 (S7). The in-vehicle device 2 sends the sending time point t3 at which it has sent (returned) the communication data to the in-vehicle apparatus 6 (S8). The in-vehicle apparatus 6 acquires the sending time point t3 at the in-vehicle device 2 (S9). Note that, in S4, the in-vehicle device 2 may also include information indicating the sending time point t3 in the communication data sent (returned) to the in-vehicle apparatus 6 as footer information. In the present embodiment, the in-vehicle apparatus 6 acquires the sending time point t1 and the reception time point t4 at the in-vehicle apparatus 6 by establishing those time points in the intra-vehicle communication unit 63, and also acquires the reception time point t2 and the sending time point t3 at the in-vehicle device 2 by receiving communication data from the in-vehicle device 2.

Based on the sending time point t1 and the reception time point t4 at the in-vehicle apparatus 6 and the reception time point t2 and the sending time point t3 at the in-vehicle device 2, the control unit 60 of the in-vehicle apparatus 6 calculates the following: the time from when the in-vehicle apparatus 6 has sent the communication data to when the in-vehicle device 2 has received the communication data (measured required sending time); the time from when the in-vehicle device 2 has sent the communication data to when the in-vehicle apparatus 6 has received the communication data (measured required reception time); and the time from when the in-vehicle device 2 has received the communication data to when it has sent (returned) the communication data to the in-vehicle apparatus 6 (measured required processing time). Specifically, the measured required sending time is calculated by t2−t1, the measured required reception time is calculated by t4−t3, and the measured required processing time is calculated by t3−t2.

The control unit 60 of the in-vehicle apparatus 6 compares the calculated measured required times with the respective estimated required times stored in the estimated-required-time table 61a and determines whether or not the in-vehicle device 2 that has performed the communication is an unauthorized device. The control unit 60 reads, out of records stored in the estimated-required-time table 61a, a record that stores the number of the in-vehicle device 2 to which the in-vehicle apparatus has sent the communication data, and then calculates differential tolerance times (predetermined times) by multiplying the estimated required times by a tolerance rate. If the absolute values of differences between the calculated measured required times and the respective estimated required times are less than the predetermined times, the control unit 60 determines that the in-vehicle device 2 that performed the communication is an authorized device. If any of the absolute values of the differences is greater than or equal to the predetermined time, the control unit 60 determines that the in-vehicle device 2 that performed the communication is an unauthorized device.

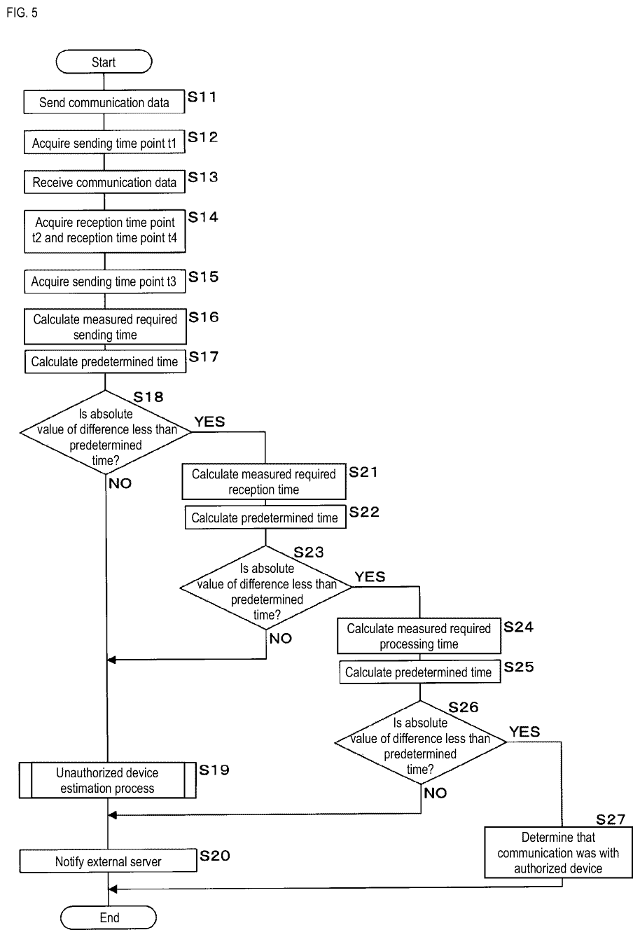

FIG. 5 is a flowchart illustrating the processing executed by the control unit 60 of the in-vehicle apparatus 6 according to Embodiment 1. For example, at a time before a vehicle component 3 is driven, the control unit 60 of the in-vehicle apparatus 6 starts the following processing with respect to the in-vehicle device 2 to which the vehicle component 3 is connected. The control unit 60 sends communication data to the in-vehicle device 2 (S11). The control unit 60 acquires the sending time point t1 at the in-vehicle apparatus 6 (S12). The control unit 60 receives communication data sent (returned) from the in-vehicle device 2 (S13), and acquires the reception time point t2 at the in-vehicle device 2 and the reception time point t4 at the in-vehicle apparatus 6 (S14). The control unit 60 acquires, from the in-vehicle device 2, the sending time point t3 at the in-vehicle device 2 (S15). The control unit 60 calculates the measured required sending time based on the sending time point t1 and the reception time point t2 (S16), and calculates the predetermined time with respect to the estimated required sending time based on the estimated-required-time table 61a (S17). The control unit 60 determines whether or not the absolute value of the difference between the measured required sending time and the estimated required sending time is less than the predetermined time (S18). If the absolute value of the difference is greater than or equal to the predetermined time (S18: NO), the control unit 60 performs an unauthorized device estimation process (S19), notifies the external server 100 of the estimation result (S20), and ends the processing. The unauthorized device estimation process will be described later. If the absolute value of the difference is less than the predetermined time (S18: YES), the control unit 60 calculates the measured required reception time based on the sending time point t3 and the reception time point t4 (S21), and calculates the predetermined time with respect to the estimated required reception time based on the estimated-required-time table 61a (S22). The control unit 60 determines whether or not the absolute value of the difference between the measured required reception time and the estimated required reception time is less than the predetermined time (S23). If the absolute value of the difference is greater than or equal to the predetermined time (S23: NO), the control unit 60 advances the processing to S19. If the absolute value of the difference is less than the predetermined time (S23: YES), the control unit 60 calculates the measured required processing time based on the reception time point t2 and the sending time point t3 (S24), and calculates the predetermined time with respect to the estimated required processing time based on the estimated-required-time table 61a (S25). The control unit 60 determines whether or not the absolute value of the difference between the measured required processing time and the estimated required time is less than the predetermined time (S26). If the absolute value of the difference is greater than or equal to the predetermined time (S26: NO), the control unit 60 advances the processing to S20, notifies the external server 100 via the extra-vehicle communication apparatus 1 that an unauthorized device is connected to the in-vehicle network 4, and ends the processing. If the absolute value of the difference is less than the predetermined time (S26: YES), the control unit 60 determines that the communication was performed with an authorized in-vehicle device (authorized device) (S27), and ends the processing.

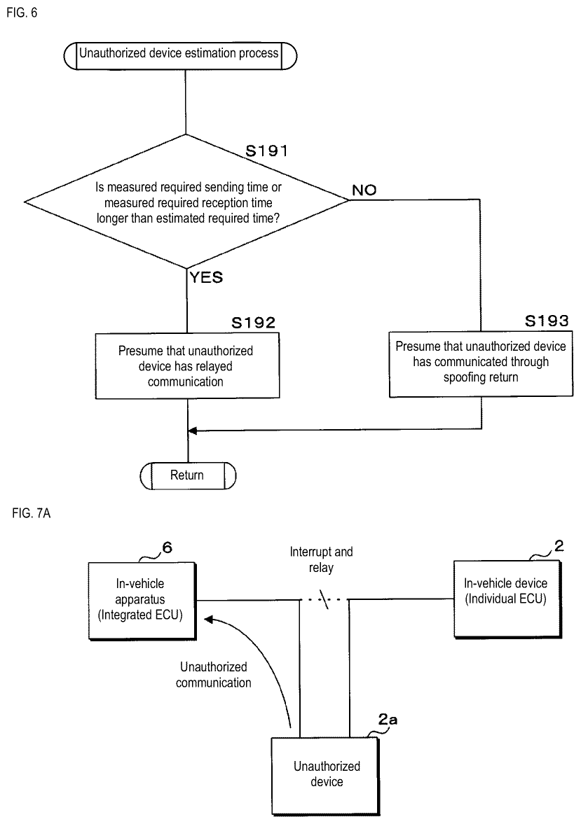

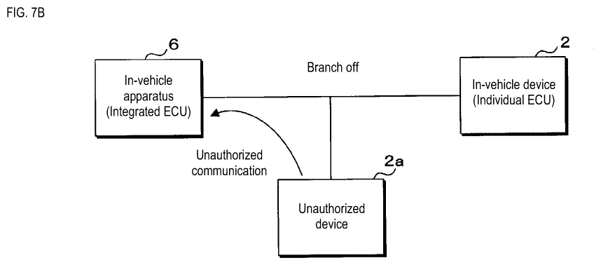

FIG. 6 is a flowchart illustrating the unauthorized device estimation process, and FIG. 7 illustrates examples of the connection of an unauthorized device 2a. The control unit 60 of the in-vehicle apparatus 6 determines whether or not the measured required sending time or the measured required reception time is longer than the estimated required time (S191). If the measured required sending time or the measured required reception time is longer than the estimated required time (S191: YES), the control unit 60 presumes that, as shown in FIG. 7A, an unauthorized device 2a has interrupted direct communication between the in-vehicle apparatus 6 and an authorized in-vehicle device 2 (an authorized device) and relayed communication between the in-vehicle apparatus 6 and the authorized in-vehicle device 2 (S192). If the measured required sending time or the measured required reception time is shorter than the estimated required time (S191: NO), the control unit 60 presumes that, as shown in FIG. 7B, an unauthorized device 2a, the unauthorized device 2a being branched off and connected between the in-vehicle apparatus 6 and an authorized in-vehicle device 2 (authorized device) and simulating the authorized in-vehicle device (authorized device), has communicated with the in-vehicle apparatus 6 by pretending to be the authorized in-vehicle device 2 (authorized device) (S193).

According to the above-described configuration and processing, the control unit 60 of the in-vehicle apparatus 6 can detect an unauthorized device connected to the in-vehicle network by comparing the measured required time during communication with an in-vehicle device 2 with the estimated required time and determining whether or not the in-vehicle device that has communicated is an unauthorized device. Note that if the control unit 60 of the in-vehicle apparatus 6 determines that the in-vehicle device that has communicated is an unauthorized device, a notification to that effect may be given through a user interface included in the vehicle C. In the present embodiment, the integrated ECU 6 corresponds to the in-vehicle apparatus, and the individual ECUs 2 correspond to the in-vehicle devices. Alternatively, a configuration may be adopted in which separate individual ECUs 2 correspond to the in-vehicle apparatus and the in-vehicle devices.

### Embodiment 2

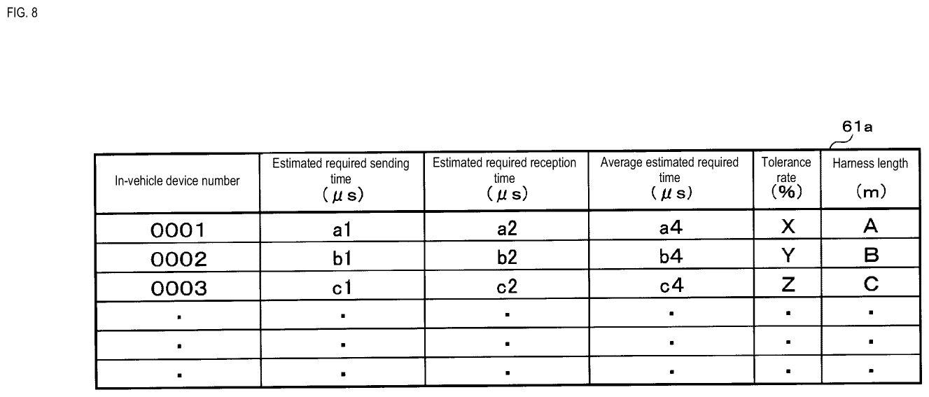

FIG. 8 is an explanatory diagram illustrating an example of an estimated-required-time table 61a according to Embodiment 2. The control unit 60 of the in-vehicle apparatus (integrated ECU) 6 according to Embodiment 2 determines whether or not an in-vehicle device 2 that has communicated is an unauthorized device based on an average required time, which is the average value of the required sending time and the required reception time.

The management items (fields) of the estimated-required-time table 61a according to Embodiment 2 include an “average estimated required time” field. The “average estimated required time” field stores the average value (average estimated required time) of the values stored in the “estimated required sending time” field and the “estimated required reception time” field.

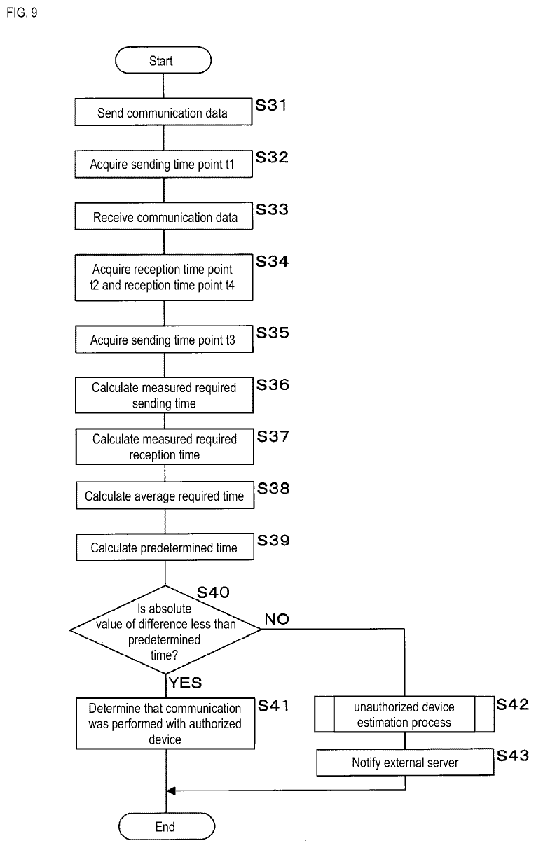

FIG. 9 is a flowchart illustrating the processing executed by the control unit 60 of the in-vehicle apparatus 6 according to Embodiment 2. The processing according to S31 to S36 is similar to the processing according to S11 to S16 in FIG. 5. The control unit 60 calculates the measured required reception time based on the sending time point t3 and the reception time point t4 (S37). The control unit 60 calculates an average measured required time by averaging the measured required sending time and the measured required reception time (S38). The control unit 60 calculates a predetermined time with respect to the average estimated required time based on the estimated-required-time table 61a (S39). The control unit 60 determines whether or not the absolute value of the difference between the average estimated required time and the average measured required time is less than the predetermined time (S40). If the absolute value of the difference is less than the predetermined time (S40: YES), the control unit 60 determines that the communication was performed with an authorized in-vehicle device (authorized device) (S41), and ends the processing. If the absolute value of the difference is greater than or equal to the predetermined time (S40: NO), the control unit 60 performs an unauthorized device estimation process (S42), notifies the external server of the result of the unauthorized device estimation process (S43), and ends the processing.

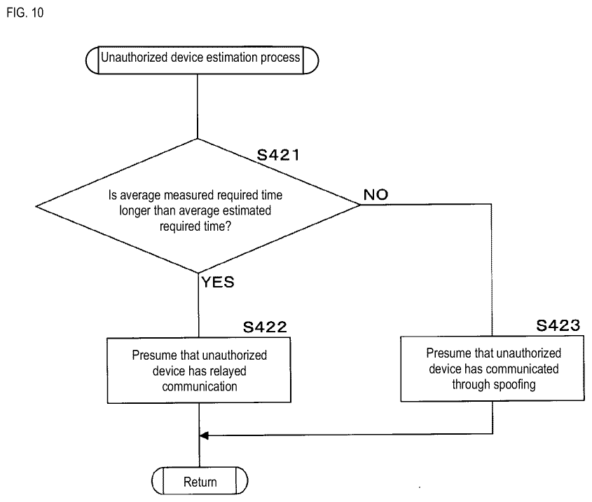

FIG. 10 is a flowchart illustrating the unauthorized device estimation process according to Embodiment 2. The control unit 60 of the in-vehicle apparatus 6 determines whether or not the average measured required time is longer than the average estimated required time (S421). If the average measured required time is longer than the average estimated required time (S421: YES), the control unit 60 presumes that, as shown in FIG. 7A, an unauthorized device 2a has interrupted direct communication between the in-vehicle apparatus 6 and an authorized in-vehicle device 2 (authorized device) and relayed communication between the in-vehicle apparatus 6 and the authorized in-vehicle device 2 (S422). If the average measured required time is shorter than the average estimated required time (S421: NO), the control unit 60 presumes that, as shown in FIG. 7B, an unauthorized device 2a, the unauthorized device 2a being branched off and connected between the in-vehicle apparatus 6 and an authorized in-vehicle device 2 (authorized device) and simulating the authorized in-vehicle device (authorized device), has communicated with the in-vehicle apparatus 6 by pretending to be the authorized in-vehicle device 2 (authorized device) (S423).

The embodiments disclosed herein should be considered in all respects illustrative and not restrictive. The technical features described in each example can be combined with each other, and the scope of the disclosure is intended to embrace all changes that come within the appended claims, as well as the range of equivalency of the claims. Additionally, the independent and dependent claims set forth in the claims can be combined with each other in any combination, regardless of the form of recitation. Furthermore, although the form (multiple dependent claim form) in which a claim recites two or more other claims is used in the claims, the claims are not limited to this form. The form in which a multiple dependent claim (multi-multi claim) recites at least one multiple dependent claim may also be used in the claims.

1. An in-vehicle apparatus installed in a vehicle and configured to perform communication with at least one in-vehicle device connected to an in-vehicle network of the vehicle, comprising:
a control unit configured to perform control related to the communication,
wherein the control unit acquires a sending time point and a reception time point of communication data sent and received during the communication with the in-vehicle device; compares an estimated required time stored in an accessible storage area in advance, with a measured required sending time from the sending time point at the in-vehicle apparatus to the reception time point at the in-vehicle device, or a measured required reception time from the sending time point at the in-vehicle device to the reception time point at the in-vehicle apparatus;
and determines that an unauthorized device is performing the communication by pretending to be the in-vehicle device that is authorized if the measured required sending time or the measured required reception time is shorter than the estimated required time.

2. The in-vehicle apparatus according to claim 1,
wherein the sending time point is a time point at which the sending of the communication data is completed, and the reception time point is a time point at which the reception of the communication data is completed.

3. The in-vehicle apparatus according to claim 1,
wherein the control unit determines whether or not the in-vehicle device that has performed the communication is an unauthorized device by comparing an estimated required time stored in an accessible storage area in advance, with a required time between the sending time point and the reception time point.

4. The in-vehicle apparatus according to claim 3,
wherein the at least one in-vehicle device includes a plurality of in-vehicle devices, and the estimated required time includes estimated required times, each representing an estimated duration from the sending time point to the reception time point of communication data, when the communication is performed with each of the plurality of in-vehicle devices connected to the in-vehicle network separately.

5. The in-vehicle apparatus according to claim 1,
wherein the control unit determines whether or not the in-vehicle device that has performed the communication is an unauthorized device based on a required time from the sending time point at which communication data has been sent to the reception time point at which the communication data has been received by the in-vehicle device.

6. The in-vehicle apparatus according to claim 1,
wherein the control unit determines whether or not the in-vehicle device that has performed the communication is an unauthorized device based on a required time from the sending time point at which communication data has been sent from the in-vehicle device to the reception time point at which the communication data has been received.

7. The in-vehicle apparatus according to claim 1,
wherein the control unit determines whether or not the in-vehicle device that has performed the communication is an unauthorized device based on a required time from the reception time point at which communication data has been received by the in-vehicle device to the sending time point at which communication data has been sent from the in-vehicle device.

8. (canceled)

9. The in-vehicle apparatus according to claim 1,
wherein, if the measured required sending time or the measured required reception time is longer than the estimated required time, it is determined that an unauthorized device is relaying the communication with the in-vehicle device that is authorized.

10. The in-vehicle apparatus according to claim 3,
wherein, if an absolute value of a difference between the estimated required time and the required time between the sending time point and the reception time point is greater than or equal to a predetermined time, the control unit determines that the in-vehicle device that has performed the communication is an unauthorized device.

11. An information processing method comprising:
acquiring a sending time point and a reception time point of communication data sent and received during communication with at least one in-vehicle device connected to an in-vehicle network of a vehicle;
comparing an estimated required time stored in an accessible storage area in advance, with a measured required sending time from the sending time point at the in-vehicle apparatus to the reception time point at the in-vehicle device, or a measured required reception time from the sending time point at the in-vehicle device to the reception time point at the in-vehicle apparatus; and
determining that an unauthorized device is performing the communication by pretending to be the in-vehicle device that is authorized if the measured required sending time or the measured required reception time is shorter than the estimated required time.

12. A non-transitory computer-readable storage medium storing a program for causing a computer configured to perform communication with at least one in-vehicle device connected to an in-vehicle network of a vehicle to execute processing comprising:
acquiring a sending time point and a reception time point of communication data sent and received during the communication with the in-vehicle device;
comparing an estimated required time stored in an accessible storage area in advance, with a measured required sending time from the sending time point at the in-vehicle apparatus to the reception time point at the in-vehicle device, or a measured required reception time from the sending time point at the in-vehicle device to the reception time point at the in-vehicle apparatus; and
determining that an unauthorized device is performing the communication by pretending to be the in-vehicle device that is authorized if the measured required sending time or the measured required reception time is shorter than the estimated required time.

13. The in-vehicle apparatus according to claim 2,
wherein the control unit determines whether or not the in-vehicle device that has performed the communication is an unauthorized device by comparing an estimated required time stored in an accessible storage area in advance, with a required time between the sending time point and the reception time point.

14. The in-vehicle apparatus according to claim 2,
wherein the control unit determines whether or not the in-vehicle device that has performed the communication is an unauthorized device based on a required time from the sending time point at which communication data has been sent to the reception time point at which the communication data has been received by the in-vehicle device.

15. The in-vehicle apparatus according to claim 2,
wherein the control unit determines whether or not the in-vehicle device that has performed the communication is an unauthorized device based on a required time from the sending time point at which communication data has been sent from the in-vehicle device to the reception time point at which the communication data has been received.

16. The in-vehicle apparatus according to claim 2,
wherein the control unit determines whether or not the in-vehicle device that has performed the communication is an unauthorized device based on a required time from the reception time point at which communication data has been received by the in-vehicle device to the sending time point at which communication data has been sent from the in-vehicle device.
